(19) United States
(12) Patent Application Publication
(10) Pub. No.: US 2009/0201141 A1
(43) Pub. Date: Aug. 13, 2009

(54) Seat belt status system

(76) Inventors: Dagnachew Teshome, Culver City, CA (US); Joshua Dagnachew, Culver City, CA (US); Menelik Dagnachew, Culver City, CA (US)

Correspondence Address: DAGNACHEW TESHOME, 5333 INGLEWOOD BLVD., CULVER CITY, CA, 90230, US

(21) Appl. No.: 12/069,587

(22) Filed: Feb. 12, 2008

(51) Int. Cl. B60Q 1/00

(52) U.S. Cl. 340/457.1

(57) ABSTRACT

A system and method for assessing threats from specific passengers and reducing the risk of bodily injury in the event of a threat aboard a multi-passenger commercial vehicle. The present system evaluates the latched status of a multitude of seat belts, reporting same to either a fixed position panel, or one or more portable units. The fixed panel provides the information to cabin crew members, thereby reducing the number of times they must traverse the cabin to physically inspect seat belts. In the event of a disturbance, it can be presumed that all passengers with fastened seat belts are a non-threat, while those unsecured are more likely to pose a threat. The portable receiver units can be used by sky marshal personnel to surreptitiously monitor the status of all seat belts without revealing their task of threat control.

### CROSS-REFERENCE TO RELATED APPLICATIONS

None.

### FEDERALLY SPONSORED RESEARCH

None.

### SEQUENCE LISTING

None.

### FIELD OF INVENTION

The present invention relates, in general, to the monitoring of seat belts, and in particular to the monitoring and reporting of seat belt status to persons who have a need to know such status.

### BACKGROUND

Seat belts have been in use in vehicles for a long time. While they came slowly to passenger automobiles, they were used in the very early flying vehicles. It is routine for cabin crew members of commercial aircraft to go through the cabin before departure and prior to landing to make certain that seat belts are properly buckled. This adds to the work load of a sometimes over-loaded cabin crew.

Numerous prior art patents have addressed this issue, providing means and methods of remotely checking seat belt status. Various means and sensors have been employed to allow the cabin attendants to check individual seat belts without the need to physically inspect each one. This need to know whether seat belts are fastened has taken on a new urgency since the introduction of hostile activity aboard commercial aircraft, and in particular since the American “9-11” terrorist attack in which hostile individuals took control of several aircraft and caused unheard of death and destruction.

Sensors to determine if a seat belt is buckled were first used very widely to remind the occupants of a motor vehicle to fasten their seat belts. Such reminder systems are not widely used on commercial airplanes, if at all. The crew on an airplane, that is, flight attendants, pursers or other security and safety officers are often responsible for ensuring that passengers have their seat belts buckled. During a typical four hour flight, flight attendants go around the airplane checking if passengers have their seat belts buckled an average of three times.

The prior art addresses various concerns relating to seat belts.

Patterson, in U.S. Pat. No. 6,438,477 (Aug. 20, 2002) describes a system that measures pressure on the seat to establish whether a seat is occupied, empty or contains a small object. Patterson seeks to differentiate between empty seats, those containing small, inanimate objects, and those containing a person. Patterson is not at all concerned about the effect of a seat occupied by a person who is not using their seat belt.

Breed, et al, in U.S. Pat. No. 6,445,988 (Sep. 3, 2002) teaches a system of using various sensors to determine the occupancy of a seat. As with numerous attempts to address seat belt issues, Breed is primarily concerned with determining whether a seat is occupied or vacant.

Naclario, in U.S. Pat. No. 6,448,907 (Sep. 10, 2002) addresses the crucial issue relating to keeping commercial aircraft safe from terrorists or those who seek to disrupt airline operations. Naclario teaches a system that selectively restrains passengers in their seat. He uses a latching system within the seat belt to allow remote locking of the seat belt; thereby preventing a passenger from getting up if his seat belt is remotely locked. Presumably, this would allow a cabin attendant to lock specified passengers in their seats, while allowing other passengers the freedom of getting out of their seats if desired. Naclario includes the use of a database to assess the “risk” of each passenger, permitting the use of this risk assessment to control the release or non-release of specific passengers from getting up.

While Naclario addresses a critical issue in the current political world, he fails to correctly view the actual problem and its solution. By using passenger statistics, Naclario presumes that passenger profiling is being used, or can be used to categorize people. It is generally considered unacceptable to use any form of profiling to make assessments about people. Currently, profiling of passengers is not used, thereby rendering Naclario's system void of the data it requires to function. It is unlikely in the current political environment that profiling will become acceptable any time soon. Naclario's system will, therefore, not be practical unless the current political situation changes.

Naclario also presumes that the flight deck—where his control panel would be positioned, is the proper place to make passenger risk assessments. This is also wrong. The pilot and flight deck crew are completely cut off from the cabin during flight. This is mandated by Federal Aviation Administration rules. In the event of a disturbance, the flight crew will have no ability to assess where the disturbance originates, or who is causing it. In many past attacks, cabin attendants were the first people to be rendered non-functional—either by a direct attack, or by threatening them with harm if they interfere. They, also, are unlikely to be able to assess the source of a risk, and take any defensive action. Naclario does provide for a portable unit for flight attendant use, but that also may be an early target of those seeking to disrupt the flight. In the event of a crash, locking seat belts could account for needless deaths or injuries, further making Naclarios system undesirable.

While Naclarios' system is novel, and appears to be a solution to a growing problem, it will be shown to be of little value in the real world of counter-terrorism activity.

Gleine, in U.S. Pat. No. 6,844,817 (Jan. 18, 2005), seeks to turn an aircraft in flight into a battle zone with its own prison. He provides a trap door near the cockpit. From a practical standpoint, if such a device were used, the opening would have to be small enough that any adult suddenly facing it would easily be able to extend their arms and prevent falling through. There are rarely attempts to commandeer an aircraft with a single person, so at most this might encumber one of the attackers, but could not disrupt the activities of all of the attacking party. Gleine then adds numerous offensive devices, such as tranquilizer dart guns, gas generators, noise generators, window darkening devices, etc, to fight a battle aboard the aircraft. Gleine does not consider the possibility that such devices could fall into the wrong hands, thereby providing the very people who should be constrained with an arsenal of weaponry. Even used by the “right” people, it is likely that numerous innocent people would be injured by the use of weapons during a hijacking attempt. It took years of lobbying to get a few pilots armed with side-arms. It would take considerably more time and effort to equip commercial aircraft with additional weapons.

Breed, in U.S. Pat. No. 6,950,022 (Sep. 27, 2005) addresses the problem of determining the status of passengers in a vehicle after a disruption to the normal operation of that vehicle. He uses an array of sensors such as ultrasonic, electromagnetic, electric field, chemical, weight, motion, etc to evaluate the status of passengers after the incident. Presumably, this will be valuable if an aircraft crashes, and it is unknown if any passengers survived the crash. While this adds to the body of prior art, Breed does not consider the issues relating to control or elimination of a risk threat before a catastrophic event.

Hagenbuch, in U.S. Pat. No. 7,005,976 (Feb. 28, 2006) addresses the issues relating to seat belt use, and in particular in such equipment as construction machines. Hagenbuch envisions the use of a local transmitter, located on the seat belt, to send data that correlates to the seat belt being fastened or not to a receiver. He uses signal strength as a means of communicating the seat belt status. While he uses a device on the seat belt as part of his system, he does not consider the use of this information by third parties, nor as a means of assessing risk factors beyond that of a seat belt not fastened. Additionally, by using signal strength as a status means, it is unlikely that the system would be useful with numerous seats. The system is inherently more suited to a single seat.

Craig, in U.S. Pat. No. 6,658,572 (Dec. 2, 2003) addresses the crucial issue of countermeasures against a hijacking attempt. Craig uses a system to detect the presence or lack of presence of the pilot to initiate a series of events designed to prevent hostile forces from taking control of an aircraft. While Craig's system has numerous merits, it fails simply if a hijacker holds a gun to the head of the pilot and forces the pilot to do as commanded.

The Naclario and Craig patents make clear the interest, and need for solutions to the complex issue of dealing with those people who seek to harm passengers and crew of commercial vehicles, and in extreme cases, use the vehicle as a weapon against people on the ground. None of this prior art, nor any combination of the art, solves the problem of detecting the exact source of a problem aboard a commercial multi-passenger vehicle without increasing the overall risk, and by providing the information to the right people to most likely abate the threat.

There are other prior art concepts, each adding to the overall knowledge of detecting persons who pose a threat to the well-being of passengers and crew of commercial vehicles. While this prior art adds to the body of knowledge, none fully and uniquely solves the problems associated with detecting and preventing take-over by force of these vehicles.

### ADVANTAGES

Accordingly one or more aspects of the present invention may have one or more of the following advantages:

to provide a means to monitor seat belt status;

to provide transparency of detection to people who might be attempting harm;

to provide the information obtained regarding seat belts to those who can take preventative measures;

to provide sufficient miniaturization that the users will not detect the presence of the system;

to gather the seat belt data at locations where the information can be used effectively.

to provide reduced risk of bodily injury during turbulent situations or emergency landings;

to reduce necessity of flight attendant waking up passengers to check for secured seatbelt;

to provide a system for monitoring seat belts without need for replacement of the existing seatbelt;

to provide a reliable source of passenger count without additional work load on cabin crew.

Some aspects of the invention may have one or more of the following additional advantages:

to provide a security people aboard an aircraft with information about potential adversaries;

to assist in containing a threat.

### SUMMARY

One or more aspects of the invention relates to a system and method for determining who is buckled into their seats. In the event of an attempt at taking control of a commercial vehicle by force, it is important to crew members to assess, quickly and unobtrusively, who might be part of the hijacking, and who are simply passengers. Assuming a chaotic situation as hostile persons attempt to take control of an aircraft, it can be dangerous to everyone to initially use deadly or disabling countermeasure force. It is important to contain the situation by first determining who force should be directed to, and who is simply a passenger. The pilot and flight deck crew can be presumed to be unaware of anything more than possibly that a threat exists. By current law, the cockpit door is locked in flight. The cabin crew may be assumed to be the first target of the would-be hijackers. Often, the cabin crew will be attacked as a first step, and they may be unaware of a problem until it is too late for them to participate in helping contain or stop the attack.

There are often sky marshals on commercial flights. These people are often not made known to flight crew or cabin attendants specifically so they can remain anonymous. If their presence is made know generally, they could be the first target of attackers, and rendered useless. Unfortunately, this anonymity also reduces their ability to see and be aware of what is happening in the cabin. Sitting in the middle of a cabin, sky marshals often have to deal with limited visibility. They may detect a problem, but be unable to determine exactly where the problem originates, or who is causing the problem. Once they stand up, they have effectively identified themselves, and they then become a major target of the attackers. The more information they can obtain before making themselves obvious, the better will be their ability to counter any threat. The present invention uniquely provides seat belt usage to not only cabin crew members, but also persons acting in a defensive manner, such as sky marshals at the same time. Further, it is done in such a manner that attackers will be completely unaware of whom is getting the information. The device providing the information to these defenders can be deliberately made to look like a PDA, or other common consumer electronics device, so it would be unrecognizable as a security device, even to a person sitting in an adjoining seat.

### DRAWINGS

### Figures

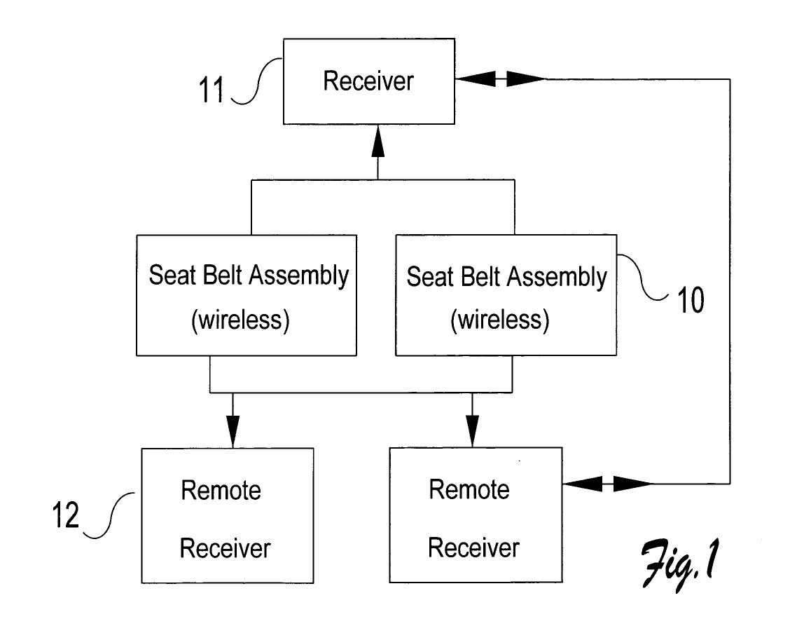

FIG. 1 is a block diagram of the elements of a system according to one aspect of the invention.

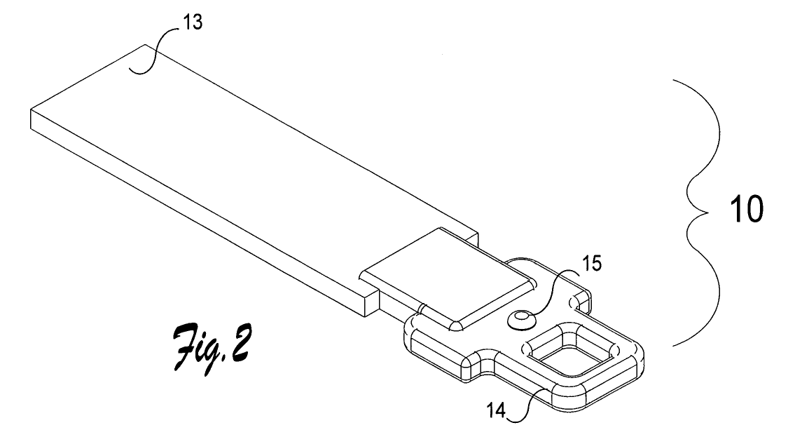

FIG. 2 Diagram of a seat belt with sensor.

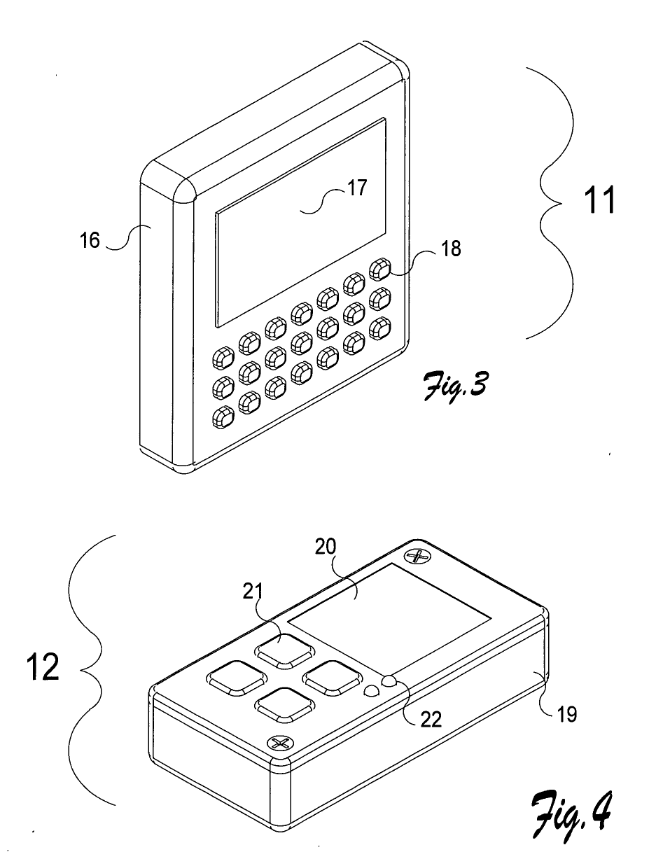

FIG. 3 Diagram of a fixed receiver.

FIG. 4 Diagram of a remote receiver.

REFERENCE NUMERALS

| | |
|---|---|
| 10 | Seat Belt Assembly |
| 11 | Receiver |
| 12 | Remote Receiver |
| 13 | Seat Belt |
| 14 | Buckle |
| 15 | Sensor |
| 16 | Panel Housing |
| 17 | display |
| 18 | Keys |
| 19 | Remote housing |
| 20 | Remote display |
| 21 | Remote Keys |
| 22 | Emergency Indicator |

FIG. 1—BLOCK DIAGRAM OF THE ELEMENTS OF A SYSTEM ACCORDING TO ONE ASPECT OF THE INVENTION—DETAILED DESCRIPTION. In accordance with one aspect of the invention, a plurality of seat belt assemblies 10 comprise seat belts 13, seat belt buckles 14, and seat belt sensors 15 [see FIG. 2]. Seat belt assemblies 10, part of a plurality of seat belts [see FIG. 2] are in communication with at least one receiver 11.

Additionally, either receiver 11, or directly one or more seat belt assemblies 10 are in communication with a plurality of remote receivers 12. Data from seat belt assembly 10 pertaining to the latched/non-latched status of seat belt 13 [see FIG. 2] is sent by wireless means from seat belt assembly 10 to either receiver 11, or remote receiver 12, or both.

FIG. 2—DIAGRAM OF A SEAT BELT WITH SENSOR—DETAILED DESCRIPTION. A seat belt assembly 10, comprising seat belt 13, connected to seat belt buckle 14, and includes sensor 15. Seat belt 13 is a conventional seat belt consisting generally of a webbing material that attaches to a seat, and when buckled goes around the middle area of a passenger sitting in a seat. Seat Belt 13 generally consists of two sections, with each section attached at one end to a portion of a seat, with the other end free. Connected to the free ends of seat belt 13 are two sections of an attachable buckle 14. Connected to one end of one the two sections of seat buckle 14 is a sensor 15 capable of transmitting in a wireless fashion data correlating to the latched/unlatched status of seat belt buckle 14.

FIG. 3—DIAGRAM OF A REMOTE RECEIVER—DETAILED DESCRIPTION. A panel 11 generally is fixed in one location on a vehicle. Panel 11 consists of a housing 16, a viewing screen 17, and one or more keys 18. Housing 16 contains the electronic components necessary to receive data from one or more seat belt assemblies 10. Viewing screen 17 provides a visual output for users, while keys 18 provide a means for users to input data or system requests.

FIG. 4—DIAGRAM OF A REMOTE RECEIVER—DETAILED DESCRIPTION. FIG. 4 depicts a portable version of panel 11, remote receiver 12. Similar to panel 11, remote receiver 12 comprises a housing 19, a viewing screen 20, keys 21, and may contain one or more indicators 22. Serving as a similar function to the electronics contained within panel 11's housing 16, remote receiver 12 contains electronics that may receive data directly from seat belt assemblies 10, or from panel 11. The data received provides information relating to the latched, unlatched status of a plurality of seat belt assemblies 10.

### ADDITIONAL FEATURES AND FUNCTIONS

The present system provides data to either cabin crew or security personnel aboard a commercial passenger vehicle regarding the seat belt status of individual passengers. It is an unfortunate reality that certain people seek to disrupt the operations of commercial vehicles, either to highjack them, or in the extreme case, to use the vehicle as a weapon of mass destruction. This has already happened in the notorious “9-11” terrorist attack in the USA on Sep. 11, 2001. In that event, nineteen members of a radical group successfully commandeered four commercial aircraft, and successfully flew three of them into targets causing massive death and destruction. In the fourth case, the passengers in the aircraft apparently overpowered the terrorists. The aircraft did not reach its intended target, but was destroyed, along with all aboard. Since that time, it has become generally the case where undercover security people [sky marshals] board aircraft, and seek to remain undetected as security personnel unless someone tries to disrupt the aircraft.

There were no sky marshals aboard the 9-11 aircraft, and therefore the present system would have had little effect. However that is not the case post 9-11. Many flights today have one or more security personnel aboard, and they are hampered by the very nature of their job. They try to maintain anonymity which helps keep them from being early targets of would-be terrorists. However that very anonymity makes it difficult at best for them to have a full and complete picture of cabin activity. By the nature of their job, these marshals often take random seats in the aircraft, thereby affording them limited views of everything going on in the cabin. They most likely cannot see enough of the cabin to get a clear picture of all of the threat sources. When they do take action, they are working with considerable handicaps. These handicaps are greatly reduced by use of the present system.

### CONCLUSIONS, RAMIFICATIONS, AND SCOPE

Accordingly, the reader will see that the current system creates a new means of monitoring the status of seat belts. While this is useful in reducing the work load of cabin attendants during normal aircraft operations, it becomes a vital tool during a possible hostile action.

In the event of hostility, the cabin attendants, along with whatever sky marshals happen to be aboard the particular aircraft, must have as much information as possible to contain the threat. If the threat is such that the cabin attendants are able to issue a “fasten seat belt” command, then anyone in a seat with their seat belt not fastened can be presumed to be a possible threat. The possible source of the threat is immediately narrowed. It is possible that a threat manifests itself such that the seat belt command is not, or cannot be given. In this case, the present invention provides at least a partial narrowing of the threat source. Most people keep their belts fastened while sitting in their seats. A potential terrorist most probably will not. When a threats manifests, the cabin attendants and sky marshal can at least eliminate all of the people sitting with their belts fastened as the source of the problem. Any reduction in determining the source will help with containment.

Many variations of this invention may be derived from the features and functions described herein. The embodiments described are merely illustrative of some of the many variations possible

Accordingly, the scope of this invention should be determined by the scope of the following claims and their legal equivalents, and not by the specific embodiments described.

1. A system for monitoring the status of seat belts, comprising;
a) a plurality of sensors included as part of a plurality of seat belts;
b) a plurality of fixed data receivers; and
c) a plurality of mobile receivers.

2. The system for monitoring the status of seat belts of claim 1, where said plurality of sensors included as part of said plurality of seat belts is in communication with said plurality of fixed data receivers.

3. The system for monitoring the status of seat belts of claim 1, where said plurality of sensors included as part of said plurality of seat belts is in communication with said plurality of mobile data receivers.

4. The system for monitoring the status of seat belts of claim 1, where said plurality of sensors included as part of said plurality of seat belts, in communication with said plurality of fixed data receivers communicates by means from the group consisting of wire, RF, IR, wireless, and ultrasonic.

5. The system for monitoring the status of seat belts of claim 1, where said plurality of sensors included as part of said plurality of seat belts, in communication with said plurality of mobile data receivers communicates by means from the group consisting of wire, RF, IR, wireless, and ultrasonic.

6. The system for monitoring the status of seat belts of claim 1, where said plurality of fixed data receivers is in communication with said plurality of mobile data receivers by means from the group consisting of wire, RF, IR, wireless, and ultrasonic

7. The system for monitoring the status of seat belts of claim 1, further including means for said fixed data receivers to display received data.

8. The system for monitoring the status of seat belts of claim 1, further including means for said mobile data receivers to display received data.

9. The system for monitoring the status of seat belts of claim 1, further including means for said fixed data receivers to accept input commands.

10. The system for monitoring the status of seat belts of claim 1, further including means for said mobile data receivers to accept input commands.

11. A method for monitoring the status of seat belts consisting of;
a) including a plurality of sensors as part of a plurality of seat belts;
b) receiving data from said seat belt sensors by a plurality of data receivers; and
c) providing an output of data.

12. The method for monitoring the status of seat belts of claim 11, where said receiving of data from said seat belt sensors provides information on the state of said seat belts.

13. The method for monitoring the status of seat belts of claim 11, where said plurality of sensors are attached to said plurality of seat belts without need for replacing said plurality of seat belts.

14. The method for monitoring the status of seat belts of claim 11, where said plurality of data receivers may be used by undercover security agents.

15. The method for monitoring the status of seat belts of claim 11, wherein said provision of output data further assists in the identification of possible threat sources.
